(19) United States
(12) Patent Application Publication
(10) Pub. No.: US 2017/0082890 A1
(43) Pub. Date: Mar. 23, 2017

(54) DISPLAY DEVICE

(71) Applicant: SAMSUNG DISPLAY CO., LTD., Yongin-si (KR)

(72) Inventor: Jung Woo PARK, Seoul (KR)

(21) Appl. No.: 15/153,650

(22) Filed: May 12, 2016

(30) Foreign Application Priority Data
Sep. 22, 2015 (KR) 10-2015-0134062

(51) Int. Cl. G02F 1/1333; G02F 1/1362; G02F 1/1343; G02F 1/1368

(52) U.S. Cl. CPC G02F 1/133377; G02F 1/1368; G02F 1/136286; G02F 1/134309

(57) ABSTRACT

A display device according to an exemplary embodiment includes a substrate; a thin film transistor disposed on the substrate; a pixel electrode connected to the thin film transistor; a roof layer disposed to be separate from the pixel electrode via a plurality of microcavities on the pixel electrode; a liquid crystal layer filling the plurality of microcavities; an encapsulation layer disposed on the roof layer and sealing the plurality of microcavities; and a cutout penetrating the substrate and the encapsulation layer.

### RELATED APPLICATIONS

This application claims priority to and the benefit of Korean Patent Application No. 10-2015-0134062 filed in the Korean Intellectual Property Office on Sep. 22, 2015, the disclosure of which is incorporated herein by reference in its entirety.

### BACKGROUND

1. Field

The described technology relates generally to a display device.

2. Description of the Related Art

A liquid crystal display (hereinafter referred to as an LCD) is one of the most widely used flat panel displays. An LCD includes two display panels provided with electric field generating electrodes, such as pixel electrodes and a common electrode, and a liquid crystal layer interposed between the two display panels. In the LCD, voltages are applied to the electric field generating electrodes to generate an electric field in the liquid crystal layer. Due to the generated electric field, liquid crystal molecules of the liquid crystal layer are aligned, and polarization of incident light is controlled, thereby displaying images.

The two display panels forming the liquid crystal display may be a thin film transistor array panel and an opposing display panel. In the thin film transistor array panel, a gate line transmitting a gate signal and a data line transmitting a data signal are formed to cross, and a thin film transistor connected to the gate line and the data line and a pixel electrode connected to the thin film transistor may be formed. A light blocking member, a color filter, a common electrode, etc. may be formed on the opposing display panel or the thin film transistor array panel.

However, in a conventional liquid crystal display, two substrates are required, and the constituent elements are respectively formed on the two substrates. Resultantly, such a display device is heavy and expensive, and the manufacturing process takes long.

The above information disclosed in this Background section is only to enhance the understanding of the background of the present disclosure, and therefore it may contain information that does not form a prior art that is already known to a person of ordinary skill in the art.

### SUMMARY

The present disclosure provides a display device having a reduced weight, thickness, cost, and processing time by manufacturing the display device using one substrate.

The present disclosure provides a stretchable display device using a display device that includes one substrate.

A display device according to an exemplary embodiment may include a substrate; a thin film transistor disposed on the substrate; a pixel electrode connected to the thin film transistor; a roof layer disposed separate from the pixel electrode via a plurality of microcavities on the pixel electrode; a liquid crystal layer disposed in the plurality of microcavities; an encapsulation layer disposed on the roof layer and sealing the plurality of microcavities; and a cutout penetrating the substrate and the encapsulation layer.

The cutout may be disposed between the adjacent microcavities among the plurality of microcavities.

The cutout may be disposed between the pixel electrodes adjacent to each other.

The display device may further include a gate line and a data line disposed on the substrate, and the cutout may extend in a direction parallel to the gate line or the data line.

The cutout may not overlap the gate line, the data line, and the thin film transistor.

The cutout further may penetrate the roof layer.

The display device may further include a first gate line, a second gate line, a third gate line, and a fourth gate line extending in a first direction on the substrate, the second gate line and the third gate line may include a bypass part bypassing in a second direction vertical to the first direction, and the cutout may be partially enclosed by the bypass part.

The cutout may extend in the second direction.

The display device may further include a data line crossing the first gate line, the second gate line, the third gate line, and the fourth gate line, and the data line may extend in a direction parallel to the cutout.

A plurality of cutouts may be disposed in a zigzag pattern.

One of the plurality of cutouts may be disposed between the third gate line and the fourth gate line and partially enclosed by the bypass part of the third gate line, and the other one of the plurality of cutouts may be disposed between the first gate line and the second gate line and partially enclosed by the bypass part of the second gate line.

The display device may further include a first data line, a second data line, a third data line, and a fourth data line extending in second direction on the substrate, the second data line and the third data line may include a bypass part bypassing in the first direction vertical to the second direction, and the cutout may be partially enclosed by the bypass part.

The cutout may extend in the first direction.

The display device may further include a gate line crossing the first data line, the second data line, the third data line, and the fourth data line, and the gate line may extend in a direction parallel to the cutout.

The plurality of cutouts may be disposed in a zigzag pattern.

One of the plurality of cutouts may be disposed between the first data line and the second data line and partially enclosed by the bypass part of the second data line, and the other one of the plurality of cutouts may be disposed between the third data line and the fourth data line and partially enclosed by the bypass part of the third data line.

The display device may further include a plurality of gate lines extending in the first direction on the substrate and connected to the thin film transistor; and a plurality of data lines extending in the second direction vertical to the first direction on the substrate and connected to the thin film transistor, the plurality of gate lines may respectively include the bypass part bypassing in the second direction, and the cutout may be partially enclosed by the bypass part.

The bypass part of the plurality of gate lines may have the same length.

The length of the cutout may be two or more times longer than the length of one side of the pixel electrode.

The plurality of cutouts may be disposed in a zigzag pattern.

The display device according to an exemplary embodiment has the following effects. The display device according to an exemplary embodiment is manufactured using one substrate and has reduced weight, thickness, cost, and process time. In addition, by forming the cutouts penetrating the substrate, the stretchable display device may be easily realized.

### BRIEF DESCRIPTION OF THE DRAWINGS

FIG. 1 is a plan view of a display device, according to an exemplary embodiment.

FIG. 2 is a plan view of a display device, according to an exemplary embodiment.

FIG. 3 is a plan view of a part of a display device, according to an exemplary embodiment.

FIG. 4 is a cross-sectional view of a display device, according to an exemplary embodiment of FIG. 3 taken along line IV-IV.

FIG. 5 is a cross-sectional view of a display device, according to an exemplary embodiment of FIG. 3 taken along line V-V.

FIG. 6 is a plan view of a display device, according to an exemplary embodiment.

FIG. 7 is a plan view of a part of a display device, according to an exemplary embodiment.

FIG. 8 is a cross-sectional view of a display device, according to an exemplary embodiment of FIG. 7 taken along line VIII-VIII.

FIG. 9 is a cross-sectional view of a display device, according to an exemplary embodiment of FIG. 7 taken along line IX-IX.

FIG. 10 is a plan view of a part of a display device, according to an exemplary embodiment.

FIG. 11 is a plan view of a part of a display device, according to an exemplary embodiment.

### DETAILED DESCRIPTION

The present disclosure will be described more fully hereinafter with reference to the accompanying drawings, in which exemplary embodiments of the present disclosure are shown. As those skilled in the art would realize, the described embodiments may be modified in various different ways, without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or one or more intervening elements may also be present. In contrast, when an element is referred to as being “directly on” another element, there may be no intervening elements present.

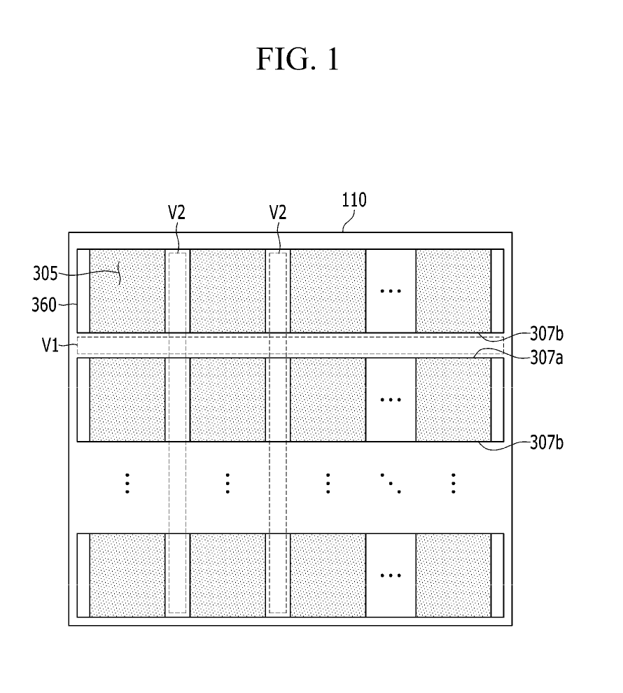

FIG. 1 is a plan view of a display device, according to an exemplary embodiment. The display device includes a substrate 110 made of a material such as glass or plastic.

A microcavity 305 is disposed on the substrate 110 and covered by a roof layer 360. The roof layer 360 extends in a row direction, and a plurality of microcavities 305 are disposed under the roof layer 360. However, the present disclosure is not limited thereto and the roof layer 360 may extend in a column direction.

The microcavities 305 may be arranged in a matrix form, a first region V1 is disposed between the microcavities 305 adjacent in a row direction, and a second region V2 is disposed between the microcavities 305 adjacent in a column direction.

The first region V1 is disposed between the plurality of roof layers 360. The microcavity 305 is not covered by the roof layer 360 to be exposed in the portion contacting the first region V1. These portions are referred to as injection holes.

The injection holes are formed at both edges of the microcavity 305. The injection holes include a first injection hole 307a and a second injection hole 307b. The first injection hole 307a is formed to expose a lateral surface of a first edge of the microcavity 305, and the second injection hole 307b is formed to expose a lateral surface of a second edge of the microcavity 305. The lateral surface of the first edge and the lateral surface of the second edge of the adjacent microcavities 305 face each other.

Each roof layer 360 is formed to be spaced apart from the substrate 110 between the adjacent second regions V2 to form the microcavity 305. That is, the roof layer 360 is formed to cover the remaining lateral surfaces except the lateral surfaces of the first edge and the second edge in which the injection holes 307a and 307b are formed.

The aforementioned structure of the display device is just an example, and various modifications are feasible. For example, the microcavity 305, the first region V1, and the second region V2 may be arranged differently, the plurality of roof layers 360 may be connected to each other in the first region V1, and a portion of each roof layer 360 may be formed to be spaced apart from the substrate 110 in the second region V2 to connect the adjacent microcavities 305 to each other.

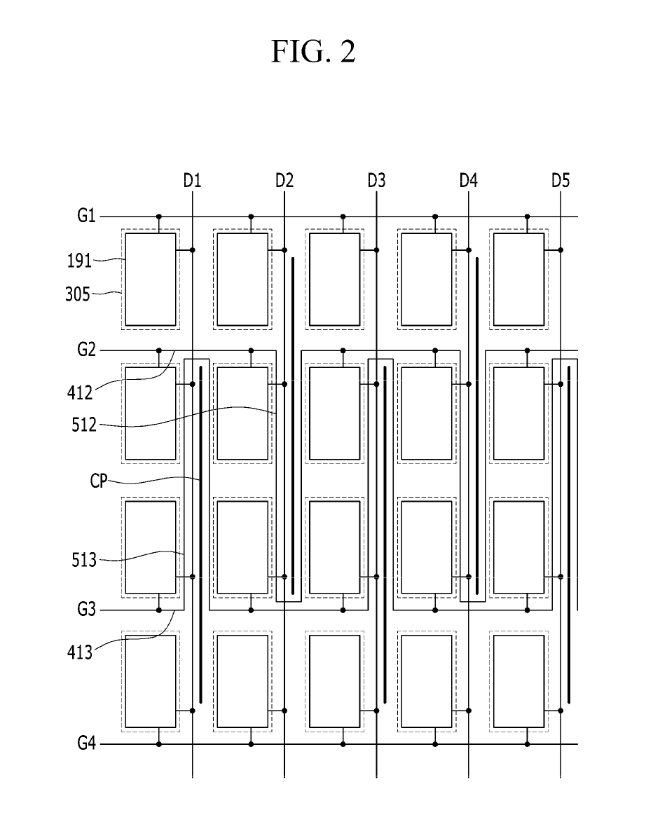

FIG. 2 is a plan view of a display device, according to an exemplary embodiment. The display device shown in FIG. 2 is the same display device shown in FIG. 1. When illustrating the constituent elements shown in FIG. 1 and FIG. 2, the constituent elements are respectively shown through separate drawings for simplicity. Furthermore, FIG. 1 and FIG. 2 commonly show the microcavity 305.

As shown in FIG. 2, a plurality of gate lines G1, G2, G3, and G4 and a plurality of data lines D1, D2, D3, D4, and D5 are formed on the substrate. In addition, a plurality of pixel electrodes 191 connected to the plurality of gate lines G1, G2, G3, and G4 and the plurality of data lines D1, D2, D3, D4, and D5 are formed. The plurality of pixel electrodes 191 are disposed in a matrix shape including a plurality of pixel rows and a plurality of pixel columns, and each pixel electrode 191 is formed in the microcavity 305. A cutout CP is formed between the plurality of microcavities 305.

The plurality of gate lines G1, G2, G3, and G4 mainly extend in a first direction. The first direction may, for example, be a horizontal direction. The plurality of gate lines G1, G2, G3, and G4 includes a first gate line G1, a second gate line G2, a third gate line G3, and a fourth gate line G4. That is, in a plan view, the second gate line G2 is positioned below the first gate line G1, the third gate line G3 is positioned below the second gate line G2, and the fourth gate line G4 is positioned below the third gate line G3. FIG. 2 only shows four gate lines G1, G2, G3, and G4. FIG. 2 shows a part of the entire gate lines, and four gate lines G1, G2, G3, and G4 may be repeatedly disposed on the substrate 110.

The first gate line G1 and the fourth gate line G4 extend in the first direction and do not separately include a bypass part. The second gate line G2 and the third gate line G3 include main lines 412 and 413 that extend in the first direction and bypass parts 512 and 513 that bypass in a second direction. The second direction may be a direction vertical to the first direction. For example, the second direction may be a vertical direction. The second gate line G2 may include a first bypass part 512 bypassing in the second direction between the second pixel column and the third pixel column and a second bypass part 512 bypassing in the second direction between the fourth pixel column and the fifth pixel column. The third gate line G3 may include a first bypass part 513 bypassing in the second direction between the first pixel column and the second pixel column and a second bypass part 513 bypassing in the second direction between the third pixel column and the fourth pixel column.

In the plan view, the bypass part 512 of the second gate line G2 protrudes in the lower direction from the main line 412 of the second gate line G2. In the plan view, the bypass part 513 of the third gate line G3 protrudes in the upper direction from the main line 413 of the third gate line G3. The bypass part 512 of the second gate line G2 and the bypass part 513 of the third gate line G3 alternately protrude. That is, the bypass part 512 of the second gate line G2 and the bypass part 513 of the third gate line G3 are alternately disposed from a left end of the second pixel row and a right end of the third pixel row.

The bypass part 512 of the second gate line G2 extends to a position adjacent to the third gate line G3. However, the bypass part 512 of the second gate line G2 does not cross the third gate line G3. The bypass part 513 of the third gate line G3 extends to a position adjacent to the second gate line G2. However, the bypass part 513 of the third gate line G3 does not cross the second gate line G2. The second gate line G2 and the third gate line G3 are applied with different signals, and the second gate line G2 and the third gate line G3 are disposed not to short-circuit with each other.

The plurality of data lines D1, D2, D3, D4, and D5 substantially extend in the second direction. The plurality of data lines D1, D2, D3, D4, and D5 may cross the gate lines G1, G2, G3, and G4 and may extend in the direction parallel to the bypass parts 512 and 513 of the second gate line G2 and the third gate line G3. The plurality of data lines D1, D2, D3, D4, and D5 includes a first data line D1, a second data line D2, a third data line D3, a fourth data line D4, and a fifth data line D5. That is, in a plan view, the second data line D2 is positioned on the right of the first data line D1, the third data line D3 is positioned on the right of the second data line D2, the fourth data line D4 is positioned on the right of the third data line D3, and the fifth data line D5 is positioned on the right of the fourth data line D4. FIG. 2 shows a part of the entire data lines, and the five data lines D1, D2, D3, D4, and D5 may be repeatedly disposed on the substrate 110.

Each pixel electrode 191 is connected to one of the plurality of gate lines G1, G2, G3, and G4 and is connected to one of the plurality of data lines D1, D2, D3, D4, and D5. Although not shown, each pixel electrode 191 may not be connected directly to the plurality of gate lines G1, G2, G3, and G4 and the plurality of data lines D1, D2, D3, D4, and D5, but may be connected through a thin film transistor. For example, the thin film transistor may include a control terminal connected to the gate lines G1, G2, G3, and G4, an input terminal connected to the data lines D1, D2, D3, D4, and D5, and an output terminal connected to the pixel electrode 191.

The cutout CP may extend in the second direction. That is, the cutout CP may extend in the direction parallel to the data lines D1, D2, D3, D4, and D5 and the bypass parts 512 and 513. The cutout CP is partially enclosed by the bypass parts 512 and 513. The cutout CP positioned between the first pixel column and the second pixel column is enclosed by the bypass part 513 of the third gate line G3 and extends from a position adjacent to the second gate line G2 to a position adjacent to the fourth gate line G4. The cutout CP positioned between the second pixel column and the third pixel column is enclosed by the bypass parts 512 of the second gate line G2 and extends from a position adjacent to the third gate line G3 to a position adjacent to the first gate line G1. The cutout CP positioned between the third pixel column and the fourth pixel column is enclosed by the bypass part 513 of the third gate line G3 and extends from a position adjacent to the second gate line G2 to a position adjacent to the fourth gate line G4. The cutout CP positioned between the fourth pixel column and the fifth pixel column is enclosed by the bypass part 512 of the second gate line G2 and extends from a position adjacent to the third gate line G3 to a position adjacent to the first gate line G1.

The plurality of cutouts CP may be disposed in a zigzag pattern. That is, the plurality of cutouts CP are not disposed to be parallel to each other. For example, the second and fourth cutouts CP from the furthest left is positioned more on the upper side than the first and third cutouts CP.

A length of the cutout CP may be two or more times longer than the length of one side of the pixel electrode 191. The pixel electrode 191 may be substantially formed as a quadrangle including two long sides and two short sides. In this case, the length of the cutout CP may be two or more times longer than the length of the long side of the pixel electrode 191, and as shown in FIG. 2, may be about three times of the length.

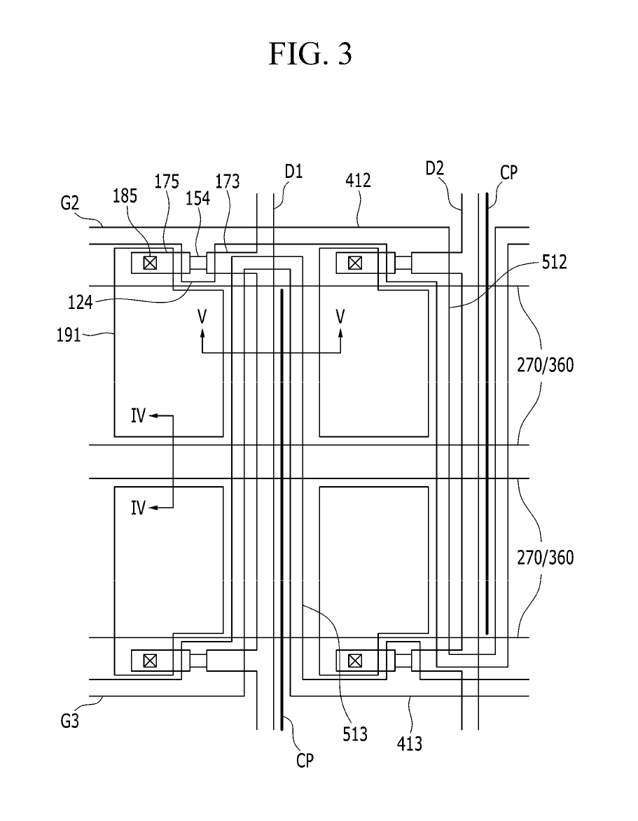

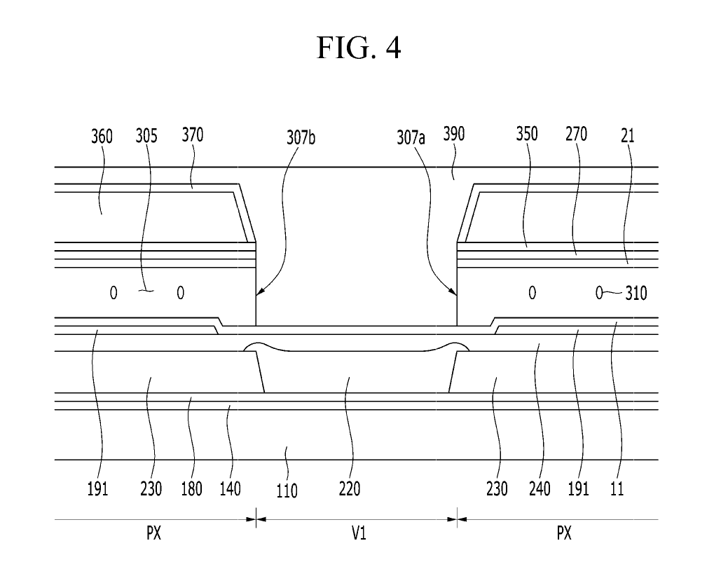

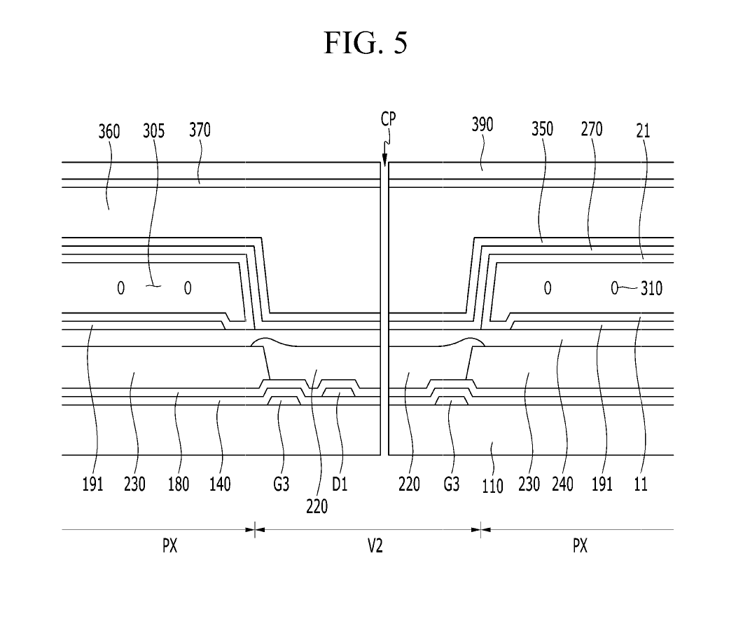

Next, the structure of the pixel of the display device according to an exemplary embodiment will be described with reference to FIG. 3 to FIG. 5. FIG. 3 is a plan view of a part of a display device, according to an exemplary embodiment, FIG. 4 is a cross-sectional view of a display device, according to an exemplary embodiment taken along line IV-IV, and FIG. 5 is a cross-sectional view of a display device, according to an exemplary embodiment taken along line V-V. FIG. 3 to FIG. 5 show four pixels connected to the second gate line G2, the third gate line G3, the first data line D1, and the second data line D2.

Referring to FIG. 3 to FIG. 5, the gate lines G2 and G3, and a gate electrode 124 protruding from the gate lines G2 and G3 are formed on the substrate 110. The substrate 110 may be made of a material that is flexible, for example, glass or plastic. The gate lines G2 and G3 mainly extend in the first direction and transmit gate signals. The gate lines G2 and G3 include main lines 412 and 413 and bypass parts 512 and 513, respectively. The main lines 412 and 413 are positioned between two microcavities 305 that are adjacent in the column direction. That is, the main lines 412 and 413 are positioned in the first region V1. The bypass parts 512 and 513 are positioned between two microcavities 305 that are adjacent in the row direction. That is, the bypass parts 512 and 513 are positioned in the second region V2.

The gate electrode 124 protrudes downward or upward from the gate lines G2 and G3 in a plan view. However, the present disclosure is not limited thereto, the protrusion shape of the gate electrode 124 may vary, and the gate electrode 124 may not protrude from the gate lines G2 and G3, and may be integrally positioned on the gate lines G2 and G3.

A gate insulating layer 140 is formed on the gate lines G2 and G3 and the gate electrode 124. The gate insulating layer 140 may be made of an inorganic insulating material such as silicon nitride (SiNx) and silicon oxide (SiOx). In addition, the gate insulating layer 140 may be formed of a single layer or multiple layers.

A semiconductor 154 is formed on the gate insulating layer 140. The semiconductor 154 may overlap the gate electrode 124. The semiconductor 154 may be made of an amorphous silicon, a polycrystalline silicon, or a metal oxide.

An ohmic contact (not shown) may be respectively formed on the semiconductor 154. The ohmic contact may be made of silicide or a material of n+ hydrogenated amorphous silicon doped with an n-type impurity at a high concentration.

The data lines D1 and D2, a source electrode 173, and a drain electrode 175 are formed on the semiconductor 154 and the gate insulating layer 140. The data lines D1 and D2 transmit data signals and mainly extend in the second direction, thereby crossing the gate lines G2 and G3. The data lines D1 and D2 are positioned between two microcavities 305 that are adjacent in the row direction. That is, the data lines D1 and D2 are positioned in the second region V2.

The source electrode 173 is formed to protrude on the gate electrode 124 from the data lines D1 and D2. That is, at least a part of the source electrode 173 may overlap the gate electrode 124. The drain electrode 175 is formed separate from the source electrode 173. At least a part of the drain electrode 175 may overlap the gate electrode 124. In the present exemplary embodiment, the shape of the source electrode 173 and the drain electrode 175 is formed of a bar shape, however the present disclosure is not limited thereto, and the shape of the source electrode 173 and the drain electrode 175 may vary. For example, the source electrode 173 may be formed in a bent U-shape enclosing the drain electrode 175. In other embodiments, the drain electrode 175 may be formed in a bent U-shape enclosing the source electrode 173. In addition, the source electrode 173 and the drain electrode 175 partially overlap the gate electrode 124, however the present disclosure is not limited thereto. The source electrode 173 and the drain electrode 175 may not overlap the gate electrode 124 and may be separated by a predetermined interval.

The gate electrode 124, the source electrode 173, and the drain electrode 175 form the thin film transistor (TFT) along with the semiconductor 154. In this case, the channel of the thin film transistor is formed in the semiconductor 154 between the source electrode 173 and the drain electrode 175.

The passivation layer 180 is formed on the data lines D1 and D2, the source electrode 173, the drain electrode 175, and the semiconductor 154. The passivation layer 180 may be made of an organic insulating material or inorganic insulating material, and may be formed of a single layer or multiple layers.

A color filter 230 is formed in each pixel PX on the passivation layer 180. Each color filter 230 may express one of primary colors, red, green, and blue. However, the colors displayed by the color filter 230 are not limited to the three primary colors red, green, and blue, and the color filter 230 may express one of cyan, magenta, yellow, and white-based colors. The color filter 230 may not be formed at the first region V1 and/or the second region V2.

A light blocking member 220 is formed at a region between the adjacent color filters 230. The light blocking member 220 is formed on a boundary of the pixel PX and the switching element to prevent light leakage. That is, the light blocking member 220 may be formed in the first region V1 and the second region V2. The color filter 230 and the light blocking member 220 may overlap in some regions.

A first insulating layer 240 may be formed on the color filter 230 and the light blocking member 220. The first insulating layer 240 may be formed of an organic insulating material, and may serve to planarize the upper surface of the color filter 230 and the light blocking member 220. The first insulating layer 240 may be made of a dual layer including a first layer made of an organic insulating material and a second layer made of an inorganic insulating material. The first insulating layer 240 may be omitted in some embodiments.

The passivation layer 180, the light blocking member 220, and the first insulating layer 240 have a contact hole 185. The contact hole 185 exposes at least a portion of the thin film transistor, and particularly exposes at least a portion of the drain electrode 175.

The pixel electrode 191 is formed on the first insulating layer 240. The pixel electrode 191 may be made of a transparent metal oxide such as indium tin oxide (ITO) and indium zinc oxide (IZO). The pixel electrode 191 is substantially formed in a rectangular shape having two long sides and two short sides, and has a shape in which the portion overlapping the thin film transistor is chamfered. However, the shape of the pixel electrode 191 is not limited thereto and may vary. Furthermore, the pixel electrode 191 may be made of a shape having a transverse stem, a longitudinal stem, and a plurality of minute branches extending therefrom. In addition, one pixel electrode 191 may be divided into two sub-pixel electrodes. In this case, the voltages applied to two sub-pixel electrodes may be differentiated to improve visibility, and the arrangement of the thin film transistors connected to the two sub-pixel electrodes may vary.

A common electrode 270 is formed on the pixel electrode 191 to be separated by a predetermined distance from the pixel electrode 191. The microcavities 305 are formed between the pixel electrode 191 and the common electrode 270. That is, the microcavities 305 are enclosed by the pixel electrode 191 and the common electrode 270.

The common electrode 270 extends in the row direction and is formed over the microcavities 305 and in the second region V2. The common electrode 270 is formed to cover a part of an upper side and a lateral side of the microcavity 305. The size of the microcavities 305 may vary depending on the size and resolution of the display device.

The present disclosure is not limited thereto, and the common electrode 270 may be formed on an insulating layer disposed between the pixel electrode 191 and the common electrode 270. In this case, the microcavity 305 may be formed on the common electrode 270.

The common electrode 270 may be made of a transparent metal material such as indium tin oxide (ITO) and indium zinc oxide (IZO. A predetermined voltage may be applied to the common electrode 270, and an electric field may be generated between the pixel electrode 191 and the common electrode 270.

Alignment layers 11 and 21 are formed over the pixel electrode 191 and under the common electrode 270, respectively. The alignment layers 11 and 21 include a first alignment layer 11 and a second alignment layer 21. The first alignment layer 11 and the second alignment layer 21 may be vertical alignment layers, and may be made of an alignment material such as polyamic acid, polysiloxane, polyimide, etc. The first and second alignment layers 11 and 21 may be connected to each other at the sidewalls of the edges of the microcavity 305.

The first alignment layer 11 is formed over the pixel electrode 191. The first alignment layer 11 may be formed directly over the first insulating layer 240 that is not covered with the pixel electrode 191. In addition, the first alignment layer 11 may also be formed in the first region V1. The second alignment layer 21 is formed under the common electrode 270 to face the first alignment layer 11.

A liquid crystal layer including liquid crystal molecules 310 is formed within the microcavity 305 formed between the pixel electrode 191 and the common electrode 270. The liquid crystal molecules 310 having negative dielectric anisotropy may stand up in a direction perpendicular to the substrate 110 when no electrical field is applied. In this case, the liquid crystal molecules 310 may be vertically aligned. However, the present disclosure is not limited thereto, and the liquid crystal molecules may have positive dielectric anisotropy and be horizontally aligned when no electrical field is applied.

When a data voltage is applied, the pixel electrode 191 generates an electric field with the common electrode 270 to determine a direction of the liquid crystal molecules 310 provided in the microcavity 305. Luminance of light passing through the liquid crystal layer is changed by the direction of the liquid crystal molecules 310 that is determined by the electric field.

A second insulating layer 350 may be formed on the common electrode 270. The second insulating layer 350 may be formed with an inorganic insulating material such as a silicon nitride (SiNx) or a silicon oxide (SiOx), and it may be omitted in some embodiments.

The roof layer 360 is formed on the second insulating layer 350. The roof layer 360 may be made of an organic material. The roof layer 360 is formed in a row direction, and is formed over the microcavities 305 and in the second region V2. The roof layer 360 is formed to cover a part of the upper side and the lateral side of the microcavities 305. The roof layer 360 may be hardened by a curing process to maintain the form of the microcavities 305. The roof layer 360 is formed to be separate from the pixel electrode 191 with the microcavities 305.

The common electrode 270 and the roof layer 360 are formed to not cover a part of the lateral side at the edge of the microcavity 305, and the portions of the microcavity 305 that are not covered by the common electrode 270 and the roof layer 360 are referred to as injection holes. The injection holes include a first injection hole 307a that exposes a lateral side at the first edge of the microcavity 305 and a second injection hole 307b that exposes a lateral side at the second edge of the microcavity 305. The first edge faces the second edge, and for example, the first edge may be an upper edge of the microcavity 305 and the second edge may be a lower edge of the microcavity 305 in a plan view. The microcavity 305 is exposed by the injection holes 307a and 307b in the process of manufacturing a display device so that an aligning agent or liquid crystal molecules 310 may be injected into the microcavity 305 through the injection holes 307a and 307b.

A third insulating layer 370 may be formed on the roof layer 360. The third insulating layer 370 may be made of an inorganic insulating material such as a silicon nitride (SiNx) and a silicon oxide (SiOx). The third insulating layer 370 may be formed to cover the upper surface and the side surface of the roof layer 360. The third insulating layer 370 has a function of protecting the roof layer 360 that is made of the organic material, and may be omitted in some embodiments.

An encapsulation layer 390 may be formed on the third insulating layer 370. The encapsulation layer 390 is formed to cover the injection hole 307 through which a part of the microcavity 305 is exposed to the outside. That is, the encapsulation layer 390 may seal the microcavity 305 so that the liquid crystal molecules 310 formed in the microcavity 305 are not discharged to the outside. Since the encapsulation layer 390 contacts the liquid crystal molecules 310, the encapsulation layer 390 may preferably be made of a material that does not react with the liquid crystal molecules 310. For example, the encapsulation layer 390 may be made of parylene or the like.

The encapsulation layer 390 may be formed to be multilayered, for example, double layered and triple layered. The double layer is configured with two layers made of different materials. The triple layer is configured with three layers, wherein materials of adjacent layers are different from each other. For example, the encapsulation layer 390 may include a first layer made of an organic insulating material and a second layer made of an inorganic insulating material.

The cutout CP penetrating the substrate 110 and the encapsulation layer 390 is formed. The cutout CP may together penetrate constituent elements formed between the substrate 110 and the encapsulation layer 390. For example, the cutout CP may penetrate one or more of the gate insulating layer 140, the passivation layer 180, the light blocking member 220, the first insulating layer 240, the common electrode 270, the second insulating layer 350, the roof layer 360, and the third insulating layer 370, or all of them.

The cutout CP is formed to penetrate the substrate 110. In this case, the substrate 110 may be easily bent in two or more directions by the plurality of cutouts CP. That is, the stretchable display device may be easily realized. For example, the display device may be formed in a non-planar shape such as a dome.

In general, the liquid crystal layer is positioned between two substrates. When forming a cutout to penetrate two substrates, the liquid crystal molecules of the liquid crystal layer may leak to the outside. Accordingly, it is not easy to realize the stretchable display device using a general liquid crystal display.

In the present exemplary embodiment, the plurality of microcavities are disposed on one substrate, and the liquid crystal layer is positioned in each microcavity. Each microcavity is independently sealed and the cutout is formed in the region between the microcavities. Accordingly, although a cutout is formed, the liquid crystal material of the liquid crystal layer does not leak to the outside.

After forming constituent elements, such as the thin film transistor, the pixel electrode 191, the common electrode 270, the roof layer 360, the encapsulation layer 390, and the like on the substrate 110, the cutout CP penetrating one or more of the constituent elements may be formed later. The cutout CP may be formed by a laser cutting process. However, the present disclosure is not limited thereto, and the cutout CP may be formed by using various cutting processes.

The cutout CP does not overlap the gate lines G2 and G3, the data lines D1 and D2, the thin film transistor, and the like. The cutout CP extends in the direction crossing the main lines 412 and 413 of the gate lines G2 and G3. When forming the cutout CP penetrating the gate lines G2 and G3 in a conventional manner, disconnection of the gate lines G2 and G3 may occur. In the present exemplary embodiment, the gate lines G2 and G3 include the bypass parts 512 and 513 and the bypass parts 512 and 513 enclose the cutout CP, thereby preventing the gate lines G2 and G3 from being disconnected by the cutout CP.

The cutout CP extends in the direction parallel to the data lines D1 and D2. When forming the cutout CP penetrating the data lines D1 and D2 in a conventional manner, disconnection of the data lines D1 and D2 may occur. In the present exemplary embodiment, the cutout CP is formed to be parallel to the data lines D1 and D2 with a predetermined interval, thereby preventing the data lines D2 and D3 from being disconnected by the cutout CP.

Although not illustrated in the drawings, a polarizer may be formed on upper and lower surfaces of the display device. The polarizer may include a first polarizer and a second polarizer. The first polarizer may be attached to a lower surface of the substrate 110, and the second polarizer may be attached to the encapsulation layer 390.

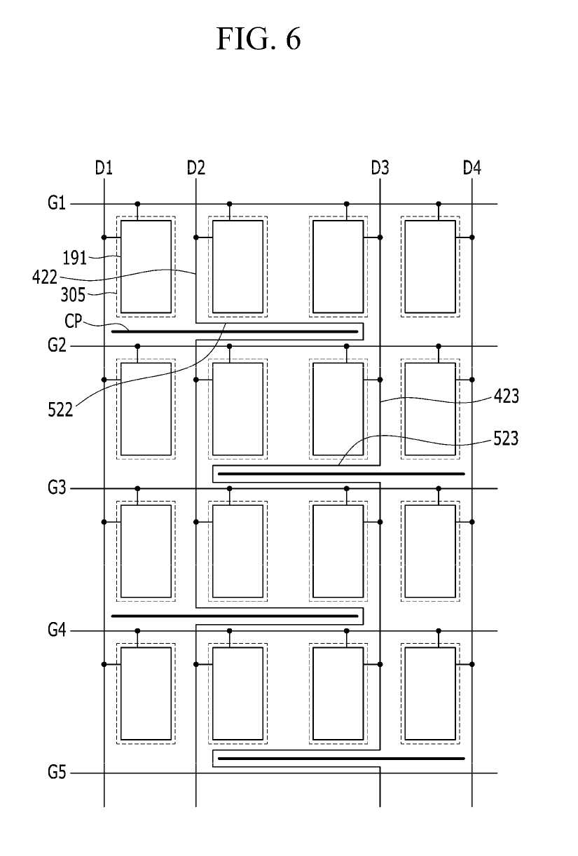

Next, the display device according to an exemplary embodiment will be described with reference to FIG. 6 to FIG. 9. The display device shown in FIG. 6 to FIG. 9 is substantially similar to the display device shown in FIG. 1 to FIG. 5. In the present exemplary embodiment, a data line includes a bypass part.

FIG. 6 is a plan view showing a display device according to an exemplary embodiment. As shown in FIG. 6, a plurality of gate lines G1, G2, G3, G4, and G5 and a plurality of data lines D1, D2, D3, and D4 are formed on the substrate. In addition, a plurality of pixel electrodes 191 connected to the plurality of gate lines G1, G2, G3, G4, and G5 and the plurality of data lines D1, D2, D3, and D4 are formed. The plurality of pixel electrodes 191 are disposed in a matrix shape including a plurality of pixel columns and a plurality of pixel rows, and each pixel electrode 191 is positioned in the microcavity 305. The cutout CP is positioned between the plurality of microcavities 305.

In the previous exemplary embodiment, some gate lines include a bypass part. However, in the present exemplary embodiment, the gate lines G1, G2, G3, G4, and G5 do not include a bypass part. Instead, the data lines D2 and D3 include bypass parts 522 and 523.

The gate lines G1, G2, G3, G4, and G5 substantially extend in a first direction, and the data lines D1, D2, D3, and D4 substantially extend in a second direction vertical to the first direction.

The first data line D1 and the fourth data line D4 extend in the second direction and do not include a bypass part. The second data line D2 and the third data line D3 include the main lines 422 and 423 extending in the second direction and the bypass parts 522 and 523 bypassing in the first direction. The second data line D2 may include a first bypass part 522 bypassing in the first direction between the first pixel row and the second pixel row and a second bypass part 522 bypassing in the first direction between the third pixel row and the fourth pixel row. The third data line D3 may include a first bypass part 523 bypassing in the first direction between the second pixel row and the third pixel row and a second bypass part 523 bypassing in the first direction between the fourth pixel row and the fifth pixel row.

In a plan view, the bypass part 522 of the second data line D2 protrudes to the right from the main line 422 of the second data line D2. In a plan view, the bypass part 523 of the third data line D3 protrudes to the left from the main line 423 of the third data line D3. The bypass part 522 of the second data line D2 and the bypass part 523 of the third data line D3 alternately protrude. That is, the bypass part 522 of the second data line D2 and the bypass part 523 of the third data line D3 are alternately disposed from the upper end to the lower end of the second pixel column and the third pixel column.

The bypass part 522 of the second data line D2 extends from a position adjacent to the first data line D1 to a position close to the third data line D3. However, the bypass part 522 of the second data line D2 does not cross the third data line D3. The bypass part 523 of the third data line D3 extends from a position adjacent to the fourth data line D4 to a position close to the second data line D2. However, the bypass part 523 of the third data line D3 does not cross the second data line D2. Since the second data line D2 and the third data line D3 are applied with different signals, the second data line D2 and the third data line D3 are disposed not to short-circuit with each other.

The cutout CP may extend in the first direction. That is, the cutout CP may extend in the direction parallel to the gate lines G1, G2, G3, G4, and G5 and the bypass parts 522 and 523. The cutout CP is partially enclosed by the bypass parts 522 and 523. The cutout CP positioned between the first pixel row and the second pixel row is enclosed by the bypass part 522 of the second data line D2 and extends from a position adjacent to the third data line D3 to a position close to the first data line Dl. The cutout CP positioned between the second pixel row and the third pixel row is enclosed by the bypass part 523 of the third data line D3 and extends from a position adjacent to the second data line D2 to a position close to the fourth data line D4. The cutout CP positioned between the third pixel row and the fourth pixel row is enclosed by the bypass part 522 of the second data line D2 and extends from a position adjacent to the third data line D3 to a position close to the first data line Dl. The cutout CP positioned below the fourth pixel row is enclosed by the bypass part 523 of the third data line D3 and extends from a position adjacent to the second data line D2 to a position close to the fourth data line D4.

The plurality of cutouts CP may be disposed in a zigzag pattern. That is, the plurality of cutouts CP are not disposed to be parallel to each other. For example, the first and third cutouts CP positioned from the top are positioned further to the left side than the second and fourth cutouts CP.

The length of the cutout CP may be two or more times longer than the length of one side of the pixel electrode 191. The pixel electrode 191 may be formed to be a quadrangle including two long sides and two short sides. In this case, the length of the cutout CP may be formed to be about two or more times longer than the length of the short side of the pixel electrode 191, and as shown in FIG. 2, about three times of the length.

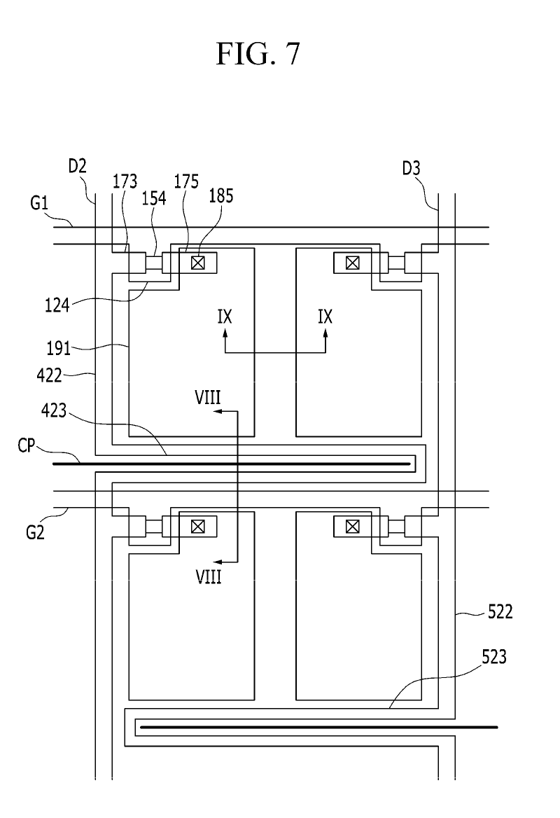

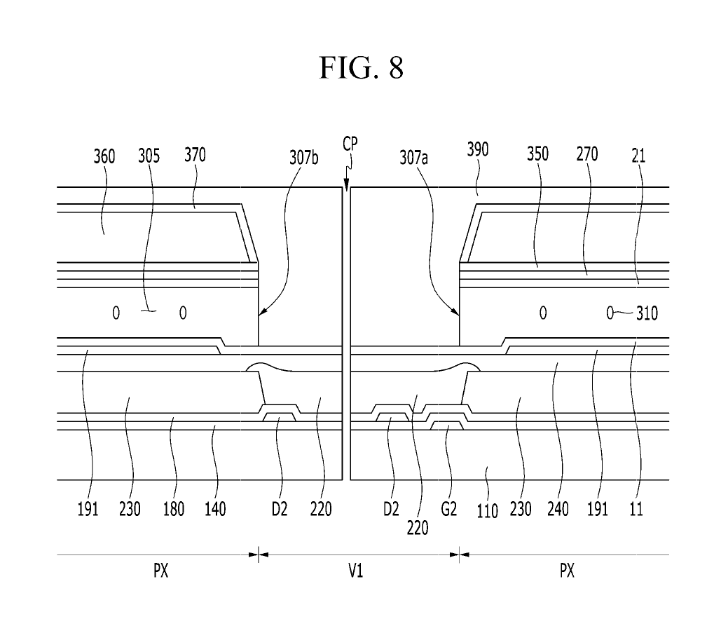

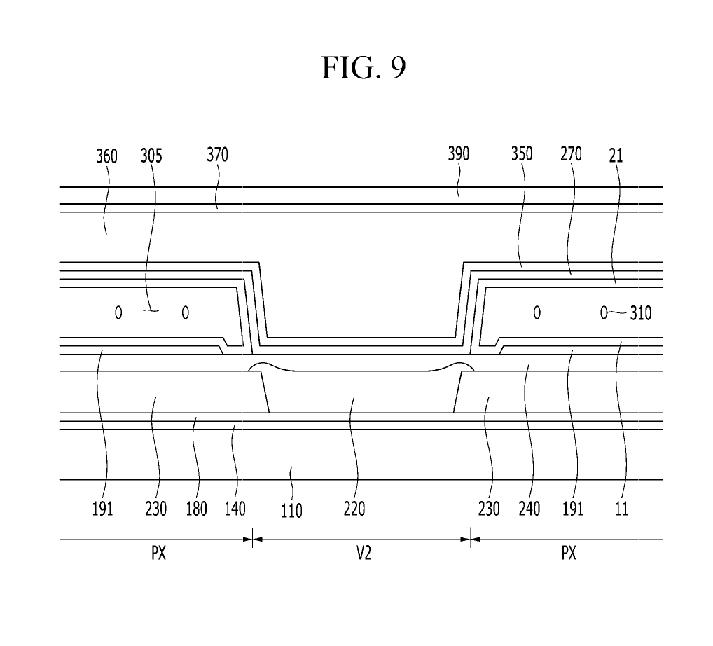

FIG. 7 is a plan view of a part of a display device, according to an exemplary embodiment, FIG. 8 is a cross-sectional view of a display device, according to an exemplary embodiment taken along line VIII-VIII, and FIG. 9 is a cross-sectional view of a display device, according to an exemplary embodiment taken along line IX-IX. FIG. 7 to FIG. 9 show four pixels connected to the first gate line G1, the second gate line G2, the second data line D2, and the third data line D3.

Referring to FIG. 7 to FIG. 9, the gate lines G1 and G2 and the gate electrode 124 protrude from the gate lines G1 and G2 and are formed on the substrate 110. The gate lines G1 and G2 extend in the approximate first direction and transmit gate signals. The gate lines G1 and G2 are positioned between two microcavities 305 adjacent in the column direction. That is, the gate lines G1 and G2 are positioned in the first region V1.

The gate electrode 124 protrudes below the gate lines G1 and G2 in a plan view. However, the present disclosure is not limited thereto, and the protrusion shape of the gate electrode 124 may vary, and the gate electrode 124 may not protrude from the gate lines G1 and G2 and be integrally positioned on the gate lines G1 and G2.

The data lines D2 and D3 transmit data signals and extend in the second direction, thereby crossing the gate lines G1 and G2. The data lines D2 and D3 include the main lines 422 and 423 positioned between two microcavities 305 that are adjacent in the row direction and the bypass parts 522 and 523 positioned between two microcavities 305 that are adjacent in the column direction. The main lines 422 and 423 are positioned in the second region V2 and the bypass parts 522 and 523 are positioned in the first region V1.

The source electrode 173 connected to the data lines D2 and D3 and the drain electrode 175 separated from the source electrode 173 are formed, and the passivation layer 180, the color filter 230, the light blocking member 220, the pixel electrode 191, the microcavities 305, the common electrode 270, the roof layer 360, the encapsulation layer 390, and the like are formed thereon.

The cutout CP penetrating the substrate 110 and the encapsulation layer 390 is formed. The cutout CP may together penetrate one or more constituent elements positioned between the substrate 110 and the encapsulation layer 390. In the present exemplary embodiment, a stretchable display device may be easily realized by the cutout CP.

The cutout CP does not overlap the gate lines G1 and G2, the data lines D2 and D3, the thin film transistor, and the like. The cutout CP extends in the direction crossing the main lines 422 and 423 of the data lines D2 and D3. When the cutout CP penetrates the data lines D2 and D3 in a conventional manner, disconnection of the data lines D2 and D3 may occur. In the present exemplary embodiment, the data lines D2 and D3 include the bypass parts 522 and 523 and the bypass parts 522 and 523 that enclose the cutout CP, thereby preventing the data lines D2 and D3 from being disconnected by the cutout CP.

The cutout CP extends in the direction parallel to the gate lines G1 and G2. When the cutout CP penetrates the gate lines G1 and G2 in a conventional manner, disconnection of the gate lines G1 and G2 may occur. In the present exemplary embodiment, the cutout CP is formed to be parallel to the gate lines G1 and G2 by a predetermined interval, thereby preventing the gate lines G1 and G2 from being disconnected by the cutout CP.

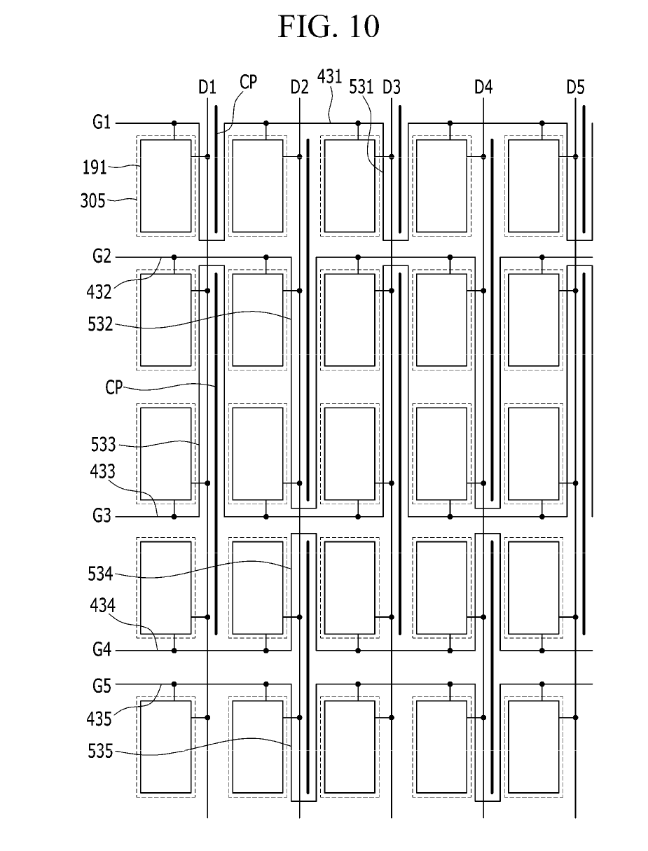

Next, the display device according to an exemplary embodiment will be described with reference to FIG. 10. The display device according to an exemplary embodiment shown in FIG. 10 is substantially similar to the display device shown in FIG. 1 to FIG. 5. In the present exemplary embodiment, all gate lines include a bypass part.

FIG. 10 is a plan view of a part of a display device according to an exemplary embodiment. As shown in FIG. 10, a plurality of gate lines G1, G2, G3, G4, and G5 and a plurality of data lines D1, D2, D3, D4, and D5 are formed on the substrate. In addition, the plurality of pixel electrodes 191 connected to the plurality of gate lines G1, G2, G3, G4, and G5 and the plurality of data lines D1, D2, D3, D4, and D5 are formed. The plurality of pixel electrodes 191 is disposed in a matrix shape including a plurality of pixel columns and a plurality of pixel rows, and each pixel electrode 191 is positioned in the microcavity 305. The cutout CP is positioned between the plurality of microcavities 305.

The plurality of gate lines G1, G2, G3, G4, and G5 includes the first gate line G1, the second gate line G2, the third gate line G3, the fourth gate line G4 and the fifth gate line G5. The gate lines G1, G2, G3, G4, and G5 respectively include the main lines 431, 432, 433, 434, and 435 extending in the first direction and the bypass parts 531, 532, 533, 534, and 535 bypassing in the second direction.

The first gate line G1 may include a first bypass part 531 bypassing in the second direction between the first pixel column and the second pixel column, and a second bypass part 531 bypassing in the second direction between the third pixel column and the fourth pixel column. The second gate line G2 may include a first bypass part 532 bypassing in the second direction between the second pixel column and the third pixel column, and a second bypass part 532 bypassing in the second direction between the fourth pixel column and the fifth pixel column. The third gate line G3 may include a first bypass part 533 bypassing in the second direction between the first pixel column and the second pixel column, and a second bypass part 533 bypassing in the second direction between the third pixel column and the fourth pixel column. The fourth gate line G4 may include a first bypass part 534 bypassing in the second direction between the second pixel column and the third pixel column, and a second bypass part 534 bypassing in the second direction between the fourth pixel column and the fifth pixel column. The fifth gate line G5 may include a first bypass part 535 bypassing in the second direction between the second pixel column and the third pixel column, and a second bypass part 535 bypassing in the second direction between the fourth pixel column and the fifth pixel column.

The cutout CP may extend in the second direction. The cutout CP may extend in the direction parallel to the data lines D1, D2, D3, D4, and D5 and the bypass parts 531, 532, 533, 534, and 535. The cutout CP is partially enclosed by the bypass parts 531, 532, 533, 534, and 535.

The plurality of cutouts CP may be disposed in a zigzag pattern, and the length of the plurality of cutouts CP may be different. For example, the length of the cutout CP positioned between the first gate line G1 and the second gate line G2 may be formed to be about three times of the length of the long side of the pixel electrode 191. The length of the cutout CP positioned between the second gate line G2 and the third gate line G3 may be also formed to be about three times of the length of the long side of the pixel electrode 191. The length of the cutout CP positioned between the third gate line G3 and the fourth gate line G4 may be also formed to be about two times of the length of the long side of the pixel electrode 191.

The length of the bypass part 531 of the first gate line G1 may be different from the length of the bypass part 532 of the second gate line G2. The length of the bypass part 532 of the second gate line G2 may be substantially the same as the length of the bypass part 533 of the third gate line G3. In addition, the length of the bypass part 531 of the first gate line G1 may be substantially the same as the length of the bypass part 534 of the fourth gate line G4 and the length of the bypass part 535 of the fifth gate line G5.

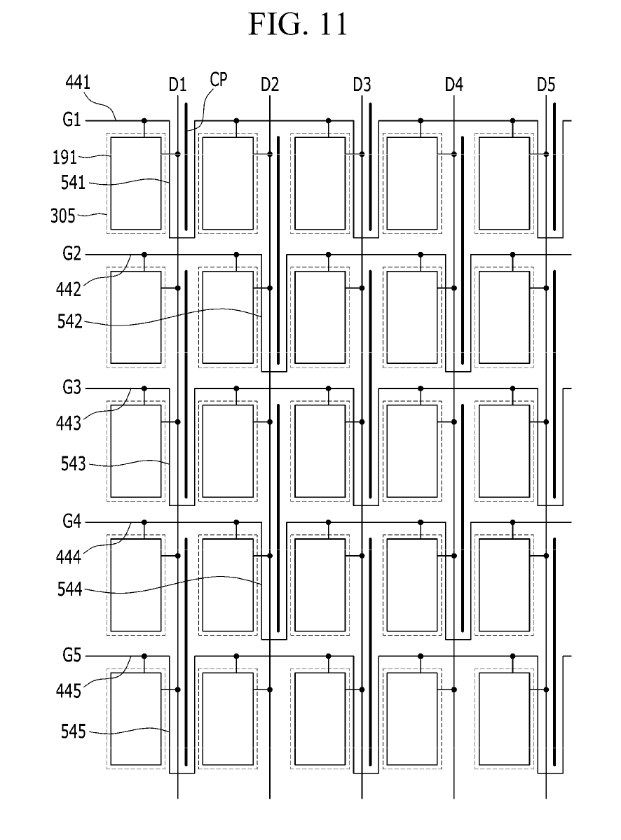

Next, the display device according to an exemplary embodiment will be described with reference to FIG. 11. The display device according to an exemplary embodiment shown in FIG. 11 is substantially similar to the display device shown in FIG. 1 to FIG. 5. In the present exemplary embodiment, the length of all the gate lines is substantially the same.

FIG. 11 is a plan view of a part of a display device according to an exemplary embodiment. As shown in FIG. 11, a plurality of gate lines G1, G2, G3, G4, and G5 and a plurality of data lines D1, D2, D3, D4, and D5 are formed on the substrate. In addition, a plurality of pixel electrodes 191 connected to the plurality of gate lines G1, G2, G3, G4, and G5 and the plurality of data lines D1, D2, D3, D4, and D5 are formed. The plurality of pixel electrodes 191 are disposed in a matrix shape including a plurality of pixel columns and a plurality of pixel rows, and each pixel electrode 191 is positioned in the microcavity 305. The cutout CP is positioned between the plurality of microcavities 305.

The plurality of gate lines G1, G2, G3, G4, and G5 includes the first gate line G1, the second gate line G2, the third gate line G3, the fourth gate line G4, and the fifth gate line G5. The gate lines G1, G2, G3, G4, and G5 include the main lines 441, 442, 443, 444, and 445 extending in the first direction and the bypass parts 541, 542, 543, 544, and 545 respectively bypassing in the second direction.

The first gate line G1 may include a first bypass part 541 bypassing in the second direction between the first pixel column and the second pixel column, and a second bypass part 541 bypassing in the second direction between the third pixel column and the fourth pixel column. The second gate line G2 may include a first bypass part 542 bypassing in the second direction between the second pixel column and the third pixel column, and a second bypass part 542 bypassing in the second direction between the fourth pixel column and the fifth pixel column. The third gate line G3 may include a first bypass part 543 bypassing in the second direction between the first pixel column and the second pixel column, and a second bypass part 543 bypassing in the second direction between the third pixel column and the fourth pixel column. The fourth gate line G4 may include a first bypass part 544 bypassing in the second direction between the second pixel column and the third pixel column, and a second bypass part 544 bypassing in the second direction between the fourth pixel column and the fifth pixel column. The fifth gate line G5 may include a first bypass part 545 bypassing in the second direction between the first pixel column and the second pixel column, and a second bypass part 545 bypassing in the second direction between the third pixel column and the fourth pixel column.

The bypass parts 541, 542, 543, 544, and 545 of the gate lines G1, G2, G3, G4, and G5 protrude in the same direction from the main lines 441, 442, 443, 444, and 445. For example, the bypass parts 541, 542, 543, 544, and 545 of the gate lines G1, G2, G3, G4, and G5 may protrude downward from the main lines 441, 442, 443, 444, and 445.

The length of the bypass parts 541, 542, 543, 544, and 545 of the gate lines G1, G2, G3, G4, and G5 may be substantially the same. The length of the bypass parts 541, 542, 543, 544, and 545 of the gate lines G1, G2, G3, G4, and G5 may be formed to be about two times of the length of the long side of the pixel electrode 191. The gate lines G1, G2, G3, G4, and G5 include the bypass parts 541, 542, 543, 544, and 545, and the bypass parts 541, 542, 543, 544, and 545 have substantially the same length such that the length of the gate lines G1, G2, G3, G4, and G5 may be substantially the same. Accordingly, signals applied to the gate lines may be prevented from being delayed.

The cutout CP may extend in the second direction. The cutout CP may extend in the direction parallel to the data lines D1, D2, D3, D4, and D5 and the bypass parts 541, 542, 543, 544, and 545. The cutout CP is partially enclosed by the bypass parts 541, 542, 543, 544, and 545. The plurality of cutouts CP may be disposed in a zigzag pattern.

While this disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the present disclosure.

### DESCRIPTION OF SYMBOLS

110: substrate

G1, G2, G3, G4, G5: gate lines

D1, D2, D3, D4, D5: data lines

412, 413, 422, 423, 431, 432, 433, 434, 435, 441, 442, 443, 444, 445: main line

512, 513, 522, 523, 531, 532, 533, 534, 535, 541, 542, 543, 544, 545: bypass part

191: pixel electrode

270: common electrode

305: microcavities

307a, 307b: injection holes

360: roof layer

390: encapsulation layer

What is claimed is:

1. A display device comprising:
a substrate;
a thin film transistor disposed on the substrate;
a pixel electrode connected to the thin film transistor;
a roof layer disposed to be separated from the pixel electrode via a plurality of microcavities disposed on the pixel electrode;
a liquid crystal layer disposed in the plurality of microcavities;
an encapsulation layer disposed on the roof layer and sealing the plurality of microcavities; and
a cutout penetrating the substrate and the encapsulation layer.

2. The display device of claim 1, wherein:
the cutout is positioned between adjacent microcavities among the plurality of microcavities.

3. The display device of claim 1, wherein:
the cutout is positioned between pixel electrodes that are adjacent to each other.

4. The display device of claim 1, further comprising:
a gate line and a data line disposed on the substrate, and
the cutout extends in a direction parallel to the gate line or the data line.

5. The display device of claim 4, wherein:
the cutout does not overlap the gate line, the data line, and the thin film transistor.

6. The display device of claim 1, wherein:
the cutout further penetrates the roof layer.

7. The display device of claim 1, further comprising:
a first gate line, a second gate line, a third gate line, and a fourth gate line extending in a first direction on the substrate,
the second gate line and the third gate line include a bypass part bypassing in a second direction vertical to the first direction, and
the cutout is partially enclosed by the bypass part.

8. The display device of claim 7, wherein:
the cutout extends in the second direction.

9. The display device of claim 7, further comprising:
a data line crossing the first gate line, the second gate line, the third gate line, and the fourth gate line, and
the data line extends in a direction parallel to the cutout.

10. The display device of claim 7, wherein:
a plurality of cutouts are disposed in a zigzag pattern.

11. The display device of claim 10, wherein:
one of the plurality of cutouts is positioned between the third gate line and the fourth gate line and is partially enclosed by the bypass part of the third gate line, and
the other one of the plurality of cutouts is positioned between the first gate line and the second gate line and is partially enclosed by the bypass part of the second gate line.

12. The display device of claim 1, further comprising:
a first data line, a second data line, a third data line, and a fourth data line extending in the second direction on the substrate,
the second data line and the third data line include a bypass part bypassing in the first direction vertical to the second direction, and
the cutout is partially enclosed by the bypass part.

13. The display device of claim 12, wherein:
the cutout extends in the first direction.

14. The display device of claim 12, further comprising:
a gate line crossing the first data line, the second data line, the third data line, and the fourth data line, and
the gate line extends in the direction parallel to the cutout.

15. The display device of claim 12, wherein:
the plurality of cutouts is disposed in a zigzag pattern.

16. The display device of claim 15, wherein:
one of the plurality of cutouts is positioned between the first data line and the second data line and is partially enclosed by the bypass part of the second data line, and
the other one of the plurality of cutouts is positioned between the third data line and the fourth data line and is partially enclosed by the bypass part of the third data line.

17. The display device of claim 1, further comprising:
a plurality of gate lines extending in the first direction on the substrate and connected to the thin film transistor; and
a plurality of data lines extending in the second direction vertical to the first direction on the substrate and connected to the thin film transistor, wherein
the plurality of gate lines respectively include the bypass part bypassing in the second direction, and
the cutout is partially enclosed by the bypass part.

18. The display device of claim 17, wherein:
the bypass part of the plurality of gate lines has the same length.

19. The display device of claim 1, wherein:
the length of the cutout is two or more times longer than the length of one side of the pixel electrode.

20. The display device of claim 1, wherein:
the plurality of cutouts is disposed in a zigzag pattern.
